(19) United States
(12) Patent Application Publication
(10) Pub. No.: US 2006/0072939 A1
(43) Pub. Date: Apr. 6, 2006

(54) Print correction for paper shrinkage

(76) Inventors: Karl Heinz Kremer, Rochester, NY (US); Karl R. Schultz, Hilton, NY (US)

Correspondence Address: BETH READ;PATENT LEGAL STAFF, EASTMAN KODAK COMPANY, 343 STATE STREET, ROCHESTER, NY, 14650-2201, US

(21) Appl. No.: 10/947,797

(22) Filed: Sep. 23, 2004

(51) Int. Cl. G03G 15/22; G03G 15/16; G03G 15/20; G09G 5/00

(52) U.S. Cl. 399/130; 345/660; 399/320; 399/297

(57) ABSTRACT

A method for printing an input image on a substrate comprising the steps of receiving the input image, transferring a marking material representation of the input image onto the substrate and scaling the input image to account for a change in size of the substrate due to printing.

### FIELD OF THE INVENTION

This invention is in the field of digital printing, and is more specifically directed to managing the images in a digital printing system.

### BACKGROUND OF THE INVENTION

Electrographic printing has become the prevalent technology for modern computer-driven printing of text and images, on a wide variety of hard copy media. This technology is also referred to as electrographic marking, electrostatographic printing or marking, and electrophotographic printing or marking. Conventional electrographic printers are well suited for high resolution and high speed printing, with resolutions of 600 dpi (dots per inch) and higher becoming available even at modest prices. As will be described below, at these resolutions, modern electrographic printers and copiers are well-suited to be digitally controlled and driven, and are thus highly compatible with computer graphics and imaging. Efforts regarding such printers or printing systems have led to continuing developments to improve their versatility practicality, and efficiency.

### BRIEF DESCRIPTION OF THE DRAWINGS

FIG. 1 is a schematic diagram of an electrographic marking or reproduction system in accordance with the present invention.

FIG. 2 is a schematic diagram of an electrographic marking or reproduction system in accordance with the present invention.

FIG. 3 is a schematic diagram of an electrographic marking or reproduction system in accordance with the present invention.

FIG. 4 is an illustration of scaling in accordance with the present invention.

FIG. 5 is an illustration of scaling in accordance with the present invention.

FIG. 6 is an illustration of an exemplary test page in accordance with the present invention.

### DETAILED DESCRIPTION

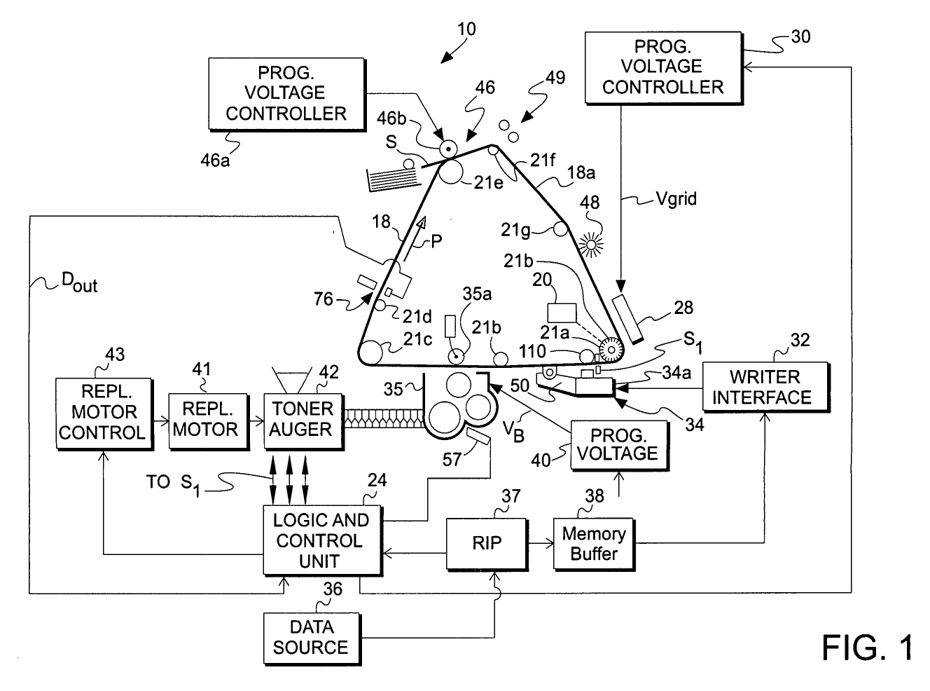

Referring to FIG. 1, a printer machine 10 includes a moving recording member such as a photoconductive belt 18 which is entrained about a plurality of rollers or other supports 21a through 21g, one or more of which is driven by a motor to advance the belt. By way of example, roller 21 a is illustrated as being driven by motor 20. Motor 20 preferably advances the belt at a high speed, such as 20 inches per second or higher, in the direction indicated by arrow p, past a series of workstations of the printer machine 10. Alternatively, belt 18 may be wrapped and secured about only a single drum.

Printer machine 10 includes a controller or logic and control unit (LCU) 24, preferably a digital computer or Microprocessor operating according to a stored program for sequentially actuating the workstations within printer machine 10, effecting overall control of printer machine 10 and its various subsystems. LCU 24 also is programmed to provide closed-loop control of printer machine 10 in response to signals from various sensors and encoders. Aspects of process control are described in U.S. Pat. No. 6,121,986 incorporated herein by this reference.

A primary charging station 28 in printer machine 10 sensitizes belt 18 by applying a uniform electrostatic corona charge, from high-voltage charging wires at a predetermined primary voltage, to a surface 18a of belt 18. The output of charging station 28 is regulated by a programmable voltage controller 30, which is in turn controlled by LCU 24 to adjust this primary voltage, for example by controlling the electrical potential of a grid and thus controlling movement of the corona charge. Other forms of chargers, including brush or roller chargers, may also be used.

An exposure station 34 in printer machine 10 projects light from a writer 34a to belt 18. This light selectively dissipates the electrostatic charge on photoconductive belt 18 to form a latent electrostatic image of the document to be copied or printed. Writer 34a is preferably constructed as an array of light emitting diodes (LEDs), or alternatively as another light source such as a Laser or spatial light modulator. Writer 34a exposes individual picture elements (pixels) of belt 18 with light at a regulated intensity and exposure, in the manner described below. The exposing light discharges selected pixel locations of the photoconductor, so that the pattern of localized voltages across the photoconductor corresponds to the image to be printed. An image is a pattern of physical light which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

After exposure, the portion of exposure medium belt 18 bearing the latent charge images travels to a development station 35. Development station 35 includes a magnetic brush in juxtaposition to the belt 18. Magnetic brush development stations are well known in the art, and are preferred in many applications; alternatively, other known types of development stations or devices may be used. Plural development stations 35 may be provided for developing images in plural grey scales, colors, or from toners of different physical characteristics. Full process color electrographic printing is accomplished by utilizing this process for each of four toner colors (e.g., black, cyan, magenta, yellow).

Upon the imaged portion of belt 18 reaching development station 35, LCU 24 selectively activates development station 35 to apply toner to belt 18 by moving backup roller 35a belt 18, into engagement with or close proximity to the magnetic brush. Alternatively, the magnetic brush may be moved toward belt 18 to selectively engage belt 18. In either case, charged toner particles on the magnetic brush are selectively attracted to the latent image patterns present on belt 18, developing those image patterns. As the exposed photoconductor passes the developing station, toner is attracted to pixel locations of the photoconductor and as a result, a pattern of toner corresponding to the image to be printed appears on the photoconductor. As known in the art, conductor portions of development station 35, such as conductive applicator cylinders, are biased to act as electrodes. The electrodes are connected to a variable supply voltage, which is regulated by programmable controller 40 in response to LCU 24, by way of which the development process is controlled.

Development station 35 may contain a two component developer mix which comprises a dry mixture of toner and carrier particles. Typically the carrier preferably comprises high coercivity (hard magnetic) ferrite particles. As an example, the carrier particles have a volume-weighted diameter of approximately 30μ. The dry toner particles are substantially smaller, on the order of 6μ to 15μ in volume-weighted diameter. Development station 35 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to photoconductive belt 18 to develop the electrostatic images thereon and the carrier material remains at development station 35. As toner is depleted from the development station due to the development of the electrostatic image, additional toner is periodically introduced by toner auger 42 into development station 35 to be mixed with the carrier particles to maintain a uniform amount of development mixture. This development mixture is controlled in accordance with various development control processes. Single component developer stations, as well as conventional liquid toner development stations, may also be used.

A transfer station 46 in printing machine 10 moves a substrate or receiver sheet S into engagement with photoconductive belt 18, in registration with a developed image to transfer the developed image to receiver sheet S. Receiver sheets S may be plain or coated paper, plastic, cardboard, wood, metal, glass or other medium or substrate capable of being handled by printer machine 10. Typically, transfer station 46 includes a charging device for electrostatically biasing movement of the toner particles from belt 18 to receiver sheet S. In this example, the biasing device is roller 46b, which engages the back of sheet S and which is connected to programmable voltage controller 46a that operates in a constant current mode during transfer. Alternatively, an intermediate member may have the image transferred to it and the image may then be transferred to receiver sheet S. After transfer of the toner image to receiver sheet S, sheet S is detacked from belt 18 and transported to fuser station 49 where the image is fixed onto sheet S, typically by the application of heat, pressure, or both. Alternatively, the image may be fixed to sheet S at the time of transfer.

To summarize then, the printer receives an input digitized image, transfers a marking material representation of the image onto the substrate with the transfer station, and fuses the marking material to the substrate using heat at the fuser station.

A cleaning station 48, such as a brush, blade, or web is also located behind transfer station 46, and removes residual toner from belt 18. A pre-clean charger (not shown) may be located before or at cleaning station 48 to assist in this cleaning. After cleaning, this portion of belt 18 is then ready for recharging and re-exposure. Of course, other portions of belt 18 are simultaneously located at the various workstations of printing machine 10, so that the printing process is carried out in a substantially continuous manner.

LCU 24 provides overall control of the apparatus and its various subsystems as is well known. LCU 24 will typically include temporary data storage memory, a central processing unit, timing and cycle control unit, and stored program control. Data input and output is performed sequentially through or under program control. Input data can be applied through input signal buffers to an input data processor, or through an interrupt signal processor, and include input signals from various switches, sensors, and analog-to-digital converters internal to printing machine 10, or received from sources external to printing machine 10, such from as a human user or a network control. The output data and control signals from LCU 24 are applied directly or through storage latches to suitable output drivers and in turn to the appropriate subsystems within printing machine 10.

Process control strategies generally utilize various sensors to provide real-time closed-loop control of the electrostatographic process so that printing machine 10 generates “constant” image quality output, from the user's perspective. Real-time process control is necessary in electrographic printing, to account for changes in the environmental ambient of the photographic printer, and for changes in the operating conditions of the printer that occur over time during operation (rest/run effects). An important environmental condition parameter requiring process control is relative humidity, because changes in relative humidity affect the charge-to-mass ratio q/m of toner particles. The ratio q/m directly determines the density of toner that adheres to the photoconductor during development, and thus directly affects the density of the resulting image. System changes that can occur over time include changes due to aging of the printhead (exposure station), changes in the concentration of magnetic carrier particles in the toner as the toner is depleted through use, changes in the mechanical position of primary charger elements, aging of the photoconductor, variability in the manufacture of electrical components and of the photoconductor, change in conditions as the printer warms up after power-on, triboelectric charging of the toner, and other changes in electrographic process conditions. Because of these effects and the high resolution of modern electrographic printing, the process control. techniques have become quite complex.

Process control sensor may be a densitometer 76, which monitors test patches that are exposed and developed in non-image areas of photoconductive belt 18 under the control of LCU 24. Densitometer 76 measures the density of the test patches, which is compared to a target density. Densitometer may include an infrared or visible light led, which either shines through the belt or is reflected by the belt onto a photodiode in densitometer 76. These toned test patches are exposed to varying toner density levels, including full density and various intermediate densities, so that the actual density of toner in the patch can be compared with the desired density of toner as indicated by the various control voltages and signals. These densitometer measurements are used to control primary charging voltage Vₒ, maximum exposure light intensity Eₒ, and development station electrode bias V_{b}. In addition, the process control of a toner replenishment control signal value or a toner concentration setpoint value to maintain the charge-to-mass ratio q/m at a level that avoids dusting or hollow character formation due to low toner charge, and also avoids breakdown and transfer mottle due to high toner charge for improved accuracy in the process control of printing machine 10. The toned test patches are formed in the interframe area of belt 18 so that the process control can be carried out in real time without reducing the printed output throughput. Another sensor useful for monitoring process parameters in printer machine 10 is electrometer probe 50, mounted downstream of the corona charging station 28 relative to direction p of the movement of belt 18. An example of an electrometer is described in U.S. Pat. No. 5,956,544 incorporated herein by this reference.

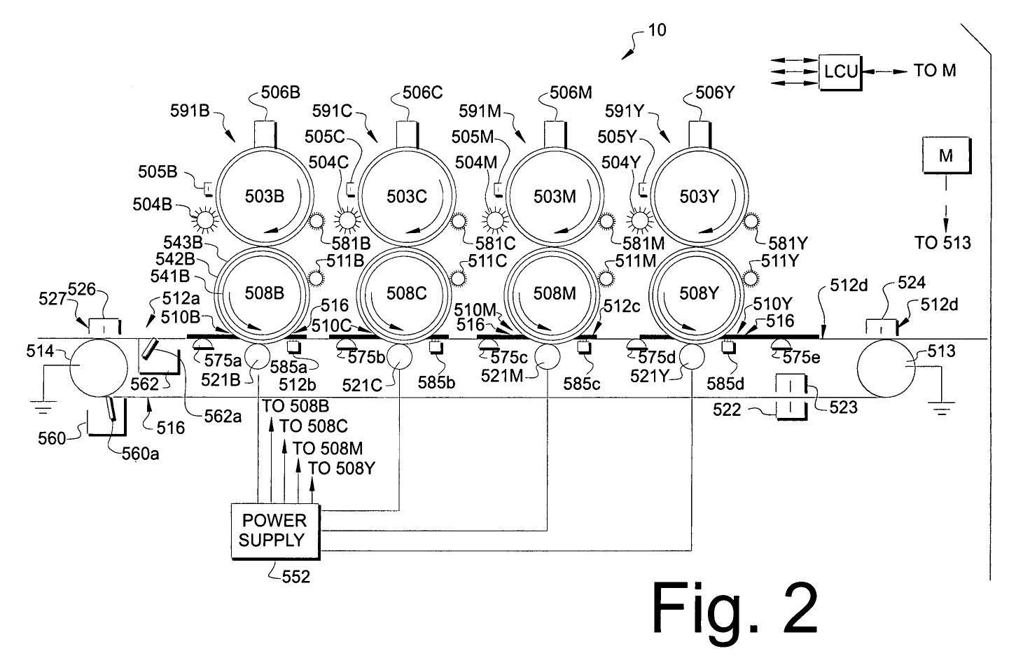

FIG. 2 shows an image forming reproduction apparatus according to another embodiment of the invention and designated generally by the numeral 10′. The reproduction apparatus 10′ is in the form of an electrophotographic reproduction apparatus and more particularly a color reproduction apparatus wherein color separation images are formed in each of four color modules (591B, 591C, 591M, 591Y) and transferred in register to a receiver member as a receiver member is moved through the apparatus while supported on a paper transport web (PTW) 516. More or less than four color modules may be utilized.

Each module is of similar construction except that as shown one paper transport web 516 which may be in the form of an endless belt operates with all the modules and the receiver member is transported by the PTW 516 from module to module. The elements in FIG. 2 that are similar from module to module have similar reference numerals with a suffix of B, C, M and Y referring to the color module to which it is associated; i.e., black, cyan, magenta and yellow, respectively. Four receiver members or sheets 512a, b, c and d are shown simultaneously receiving images from the different modules, it being understood as noted above that each receiver member may receive one color image from each module and that in this example up to four color images can be received by each receiver member. The movement of the receiver member with the PTW 516 is such that each color image transferred to the receiver member at the transfer nip of each module is a transfer that is registered with the previous color transfer so that a four-color image formed on the receiver member has the colors in registered superposed relationship on the receiver member. The receiver members are then serially detacked from the PTW and sent to a fusing station (not shown) to fuse or fix the dry toner images to the receiver member. The PTW is reconditioned for reuse by providing charge to both surfaces using, for example, opposed corona chargers 522, 523 which neutralize charge on the two surfaces of the PTW.

Each color module includes a primary image-forming member (PIFM), for example a rotating drum 503B, C, M and Y, respectively. The drums rotate in the directions shown by the arrows and about their respective axes. Each PIFM 503B, C, M and Y has a photoconductive surface, upon which a pigmented marking particle image, or a series of different color marking particle images, is formed. In order to form images, the outer surface of the PIFM is uniformly charged by a primary charger such as a corona charging device 505 B, C, M and Y, respectively or other suitable charger such as roller chargers, brush chargers, etc. The uniformly charged surface is exposed by suitable exposure means, such as for example a laser 506 B, C, M and Y, respectively or more preferably an LED or other electro-optical exposure device or even an optical exposure device to selectively alter the charge on the surface of the PIFM to create an electrostatic latent image corresponding to an image to be reproduced. The electrostatic image is developed by application of pigmented charged marking particles to the latent image bearing photoconductive drum by a development station 581 B, C, M and Y, respectively. The development station has a particular color of pigmented toner marking particles associated respectively therewith. Thus, each module creates a series of different color marking particle images on the respective photoconductive drum. In lieu of a photoconductive drum which is preferred, a photoconductive belt may be used.

As an alternative to electrophotographic recording, there may be used electrographic recording of each primary color image using stylus recorders or other known recording methods for recording a toner image on a dielectric member that is to be transferred electrostatically as described herein. Broadly, the primary image is formed using electrostatography.

Each marking particle image formed on a respective PIFM is transferred electrostatically to an outer surface of a respective secondary or intermediate image transfer member (ITM), for example, an intermediate transfer drum 508 B, C, M and Y, respectively. The PIFMs are each caused to rotate about their respective axes by frictional engagement with a respective ITM. The arrows in the ITMs indicate the directions of rotations. After transfer the toner image is cleaned from the surface of the photoconductive drum by a suitable cleaning device 504 B, C, M and Y, respectively to prepare the surface for reuse for forming subsequent toner images. The intermediate transfer drum or ITM preferably includes a metallic (such as aluminum) conductive core 541 B, C, M and Y, respectively and a compliant blanket layer 543 B, C, M and Y, respectively. The cores 541 C, M and Y and the blanket layers 543 C, M and Y are shown but not identified in FIG. 2 but correspond to similar structure shown and identified for module 591 B. The compliant layer is formed of an elastomer such as polyurethane or other materials well noted in the published literature. The elastomer has been doped with sufficient conductive material (such as antistatic particles, ionic conducting materials, or electrically conducting dopants) to have a relatively low resistivity. With such a relatively conductive intermediate image transfer member drum, transfer of the single color marking particle images to the surface of the ITM can be accomplished with a relatively narrow nip width and a relatively modest potential of suitable polarity applied by a constant voltage potential source (not shown). Different levels of constant voltage can be provided to the different ITMs so that the constant voltage on one ITM differs from that of another ITM in the apparatus.

A single color marking particle image respectively formed on the surface 542B (others not identified) of each intermediate image transfer member drum, is transferred to a toner image receiving surface of a receiver member, which is fed into a nip between the intermediate image transfer member drum and a transfer backing roller (TBR) 521B, C, M and Y, respectively, that is suitably electrically biased by a constant current power supply 552 to induce the charged toner particle image to electrostatically transfer to a receiver sheet. Each TBR is provided with a respective constant current by power supply 552. The transfer backing roller or TBR preferably includes a metallic (such as aluminum) conductive core and a compliant blanket layer. Although a resistive blanket is preferred, the TBR may be a conductive roller made of aluminum or other metal. The receiver member is fed from a suitable receiver member supply (not shown) and is suitably “tacked” to the PTW 516 and moves serially into each of the nips 510B, C, M and Y where it receives the respective marking particle image in suitable registered relationship to form a composite multicolor image. As is well known, the colored pigments can overlie one another to form areas of colors different from that of the pigments. The receiver member exits the last nip and is transported by a suitable transport mechanism (not shown) to a fuser where the marking particle image is fixed to the receiver member by application of heat and/or pressure and, preferably both. A detack charger 524 may be provided to deposit a neutralizing charge on the receiver member to facilitate separation of the receiver member from the belt 516. The receiver member with the fixed marking particle image is then transported to a remote location for operator retrieval. The respective ITMs are each cleaned by a respective cleaning device 511 B, C, M and Y to prepare it for reuse. Although the ITM is preferred to be a drum, a belt may be used instead as an ITM.

Appropriate sensors such as mechanical, electrical, or optical sensors described hereinbefore are utilized in the reproduction apparatus 10′ to provide control signals for the apparatus. Such sensors are located along the receiver member travel path between the receiver member supply through the various nips to the fuser. Further sensors may be associated with the primary image forming member photoconductive drum, the intermediate image transfer member drum, the transfer backing member, and various image processing stations. As such, the sensors detect the location of a receiver member in its travel path, and the position of the primary image forming member photoconductive drum in relation to the image forming processing stations, and respectively produce appropriate signals indicative thereof. Such signals are fed as input information to a logic and control unit LCU including a microprocessor, for example. Based on such signals and a suitable program for the microprocessor, the control unit LCU produces signals to control the timing operation of the various electrostatographic process stations for carrying out the reproduction process and to control drive by motor M of the various drums and belts. The production of a program for a number of commercially available microprocessors, which are suitable for use with the invention, is a conventional skill well understood in the art. The particular details of any such program would, of course, depend on the architecture of the designated microprocessor.

The receiver members utilized with the reproduction apparatus 10′ can vary substantially. For example, they can be thin or thick paper stock (coated or uncoated) or transparency stock. As the thickness and/or resistivity of the receiver member stock varies, the resulting change in impedance affects the electric field used in the nips 510B, C, M, Y to urge transfer of the marking particles to the receiver members. Moreover, a variation in relative humidity will vary the conductivity of a paper receiver member, which also affects the impedance and hence changes the transfer field. To overcome these problems, the paper transport belt preferably includes certain characteristics.

The endless belt or web (PTW) 516 is preferably comprised of a material having a bulk electrical resistivity. This bulk resistivity is the resistivity of at least one layer if the belt is a multilayer article. The web material may be of any of a variety of flexible materials such as a fluorinated copolymer (such as polyvinylidene fluoride), polycarbonate, polyurethane, polyethylene terephthalate, polyimides (such as Kapton.TM.), polyethylene napthoate, or silicone rubber. Whichever material that is used, such web material may contain an additive, such as an anti-stat (e.g. metal salts) or small conductive particles (e.g. carbon), to impart the desired resistivity for the web. When materials with high resistivity are used additional corona charger(s) may be needed to discharge any residual charge remaining on the web once the receiver member has been removed. The belt may have an additional conducting layer beneath the resistive layer which is electrically biased to urge marking particle image transfer. Also acceptable is to have an arrangement without the conducting layer and instead apply the transfer bias through either one or more of the support rollers or with a corona charger. It is also envisioned that the invention applies to an electrostatographic color machine wherein a generally continuous paper web receiver is utilized and the need for a separate paper transport web is not required. Such continuous webs are usually supplied from a roll of paper that is supported to allow unwinding of the paper from the roll as the paper passes as a generally continuous sheet through the apparatus.

In feeding a receiver member onto belt 516, charge may be provided on the receiver member by charger 526 to electrostatically attract the receiver member and “tack” it to the belt 516. A blade 527 associated with the charger 526 may be provided to press the receiver member onto the belt and remove any air entrained between the receiver member and the belt.

A receiver member may be engaged at times in more than one image transfer nip and preferably is not in the fuser nip and an image transfer nip simultaneously. The path of the receiver member for serially receiving in transfer the various different color images is generally straight facilitating use with receiver members of different thicknesses.

The endless paper transport web (PTW) 516 is entrained about a plurality of support members. For example, as shown in FIG. 2, the plurality of support members are rollers 513, 514 with preferably roller 513 being driven as shown by motor M to drive the PTW (of course, other support members such as skis or bars would be suitable for use with this invention). Drive to the PTW can frictionally drive the ITMs to rotate the ITMs which in turn causes the PIFMs to be rotated, or additional drives may be provided. The process speed is determined by the velocity of the PTW.

Alternatively, direct transfer of each image may be made directly from respective photoconductive drums to the receiver sheet as the receiver sheet serially advances through the transfer stations while supported by the paper transport web without ITMs. The respective toned color separation images are transferred in registered relationship to a receiver member as the receiver member serially travels or advances from module to module receiving in transfer at each transfer nip a respective toner color separation image. Either way, different receiver sheets may be located in different nips simultaneously and at times one receiver sheet may be located in two adjacent nips simultaneously, it being appreciated that the timing of image creation and respective transfers to the receiver sheet is such that proper transfer of images are made so that respective images are transferred in register and as expected.

Other approaches to electrographic printing process control may be utilized, such as those described in international publication number WO 02/10860 a1, and international publication number WO 02/14957 A1, both commonly assigned herewith and incorporated herein by this reference.

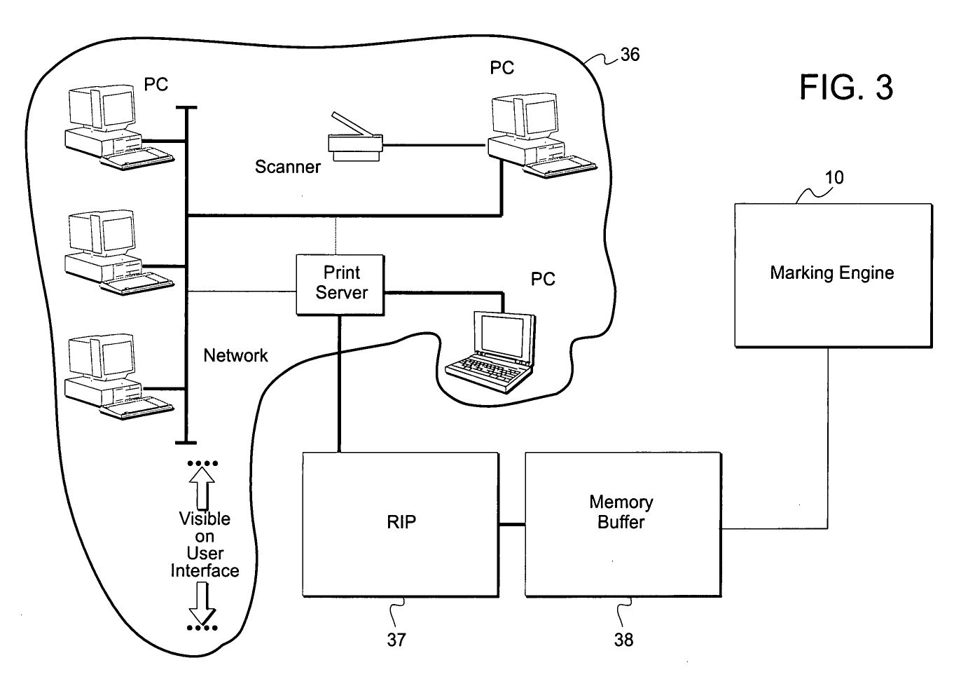

Referring to FIG. 3, image data to be printed is provided by an image data source 36, which is a device that can provide digital data defining a version of the image. Such types of devices are numerous and include computer or microcontroller, computer workstation, scanner, digital camera, etc. Multiple devices may be interconnected on a network. These image data sources are at the front end and generally include an application program that is used to create or find an image to output. The application program sends the image to a device driver, which serves as an interface between the client and the marking device. The device driver then encodes the image in a digital format that serves to describe what image is to be generated on a page. These formats may include bit-map containing files such as TIFF format, a PDL format (such as Postcript®), some variant of the foregoing, or another format recognized by the printer. Reference is made to PDF specification Version 1.5 available from Adobe Systems Incorporated. A page description language provides instructions for printing a document to a printer as bit-mapped graphics or vector graphics, for example. Other formats, such as textual version of the image may be used. A textual version of the image may include a Rich Text Format (RTF) or American Standard Code for Information Interchange (ASCII). The device driver sends the encoded image to the receiving unit of the marking device. The receiving unit may be part of the overall processor or controller of the printer. This data represents the location, color, and intensity of each pixel that is exposed.

A bitmap-containing file expresses an image as one or more bitmaps. Bitmaps may be defined in terms of rows and columns of pixels, where the density of the rows and columns determines the resolution of the image. For a color image or different levels of luminance, multiple bitmaps are overlaid or closely spaced to each other. A bitmap-containing file may be used for storing, exchanging, and printing images.

Tagged Image File Format (TIFF) is a standard file format for storing an image as one or more bit maps. TIFF supports different sizes, resolution levels, and color attributes of an image. The latest TIFF specification (e.g., TIFF Revision 6.0 at the time of this application) may be available from Adobe Systems Incorporated at the following Internet address, www.adobe.com. Print settings may be incorporated into a TIFF file.

Production print settings include features such as duplexing (i.e., making two-sided copies from various original formats), binding, pamphlet making, or other suitable characteristics applicable to mass printing procedures. One method of such incorporation is involves “wrapping” the TIFF files within a PostScript (PS) or Portable Document Format (PDF) file. A PostScript file is a file that expresses an image in an object-oriented language in terms of vector graphics. PostScript page description language is a trademark of Adobe Systems Incorporated. Portable document format (PDF) and PostScript are file formats developed by Adobe Systems Incorporated. The PDF format accepts formatting information from a variety of applications and provides a standard format that can be interchanged among different users. Portable Data Format and PostScript are trademarks of Adobe Systems Incorporated.

A TIFF file basically includes a header, an image file directory (IFD) component and a data component. The IFD component includes one or more IFD blocks. The header contains an offset address to the first IFD block within the TIFF file. The data component includes multiple data blocks. The data blocks may contain TIFF tag detail, image data, or both.

The header allocates storage units within the header for reference to data that is useful for interpreting or locating the contents of the TIFF file. (Storage units refer to bits, bytes, or words of data). For example, the header stores a byte order, a file attribute, and a first pointer. The byte order indicates the order in which bytes or words for the data blocks are organized within the file. The file attribute indicates a file attribute, such as file size, compression scheme, or any other suitable data characteristic that is useful for interpreting the TIFF file. The first pointer provides an address that points to the first IFD block within the TIFF file.

The IFD block allocates storage units within the IFD block on print settings or data on indexing of the information in the file. For example, the IFD data block includes an entry indicator, a first entry, a second entry, and an nth entry, where n is the total number of entries. The nth entry may be followed by a second pointer. The entry indicator indicates n, which is the total number of entries within the IFD block. The second pointer provides an address that points to the next IFD block until the value for the offset to the next IFD is zero, indicating that the last IFD within the TIFF file has been reached. If the value for an entry cannot fit within a defined maximum storage space limit (e.g., 4 bytes of storage space per word), the value becomes a reference pointer (i.e. offset within the file) to the actual data, which is stored elsewhere in the TIFF file.

The data block includes a plurality of bytes ranging from a first byte to an mth byte, where m is the maximum number of bytes per data block. Although m may equal n if the entry words in the IFD block provide information about each byte in the data block, m and n may differ.

An annotator may add a set of printing settings in the textual format to the IFD. The printing settings may refer to printing characteristics or attributes that affect the visual appearance of an image on a printable recording medium (e.g., paper). For example, printing settings include page layout, page background, and appearance attributes of an image or images on the page. Further, printing settings may include the manner in which jobs are printed on a printer or associated processing equipment, even if such printing settings are not ultimately evident upon a visual inspection of the resultant image on the printable recording medium. For example, production printing settings include printing processing parameters that are customary, appropriate, or desired to promote time-efficient and accurate printing operations in a high-volume commercial printing environment. Accordingly, production print settings include features such as duplexing (i.e., making two-sided copies from various original formats), binding, pamphlet making, or other parameter that materially impact the cost, efficiency, convenience, or accuracy of a mass printing process.

The annotator adds the printing settings to at least one directory data block of the directory component. In one example, the production printing settings are added to an additional block, which is referred to as an image file directory block of a TIFF file. As used herein, a bitmap-containing file that contains printing settings may be referred to as an annotated bitmap-containing file.

Signals from data source 36, in combination with control signals from LCU 24 are provided to a raster image processor (RIP) 37 for rasterization.

In general, the major roles of the RIP 37 are to: receive job information from the server; parse the header (if any) from the print job and determine the printing and finishing requirements of the job or extract the same from the PDL or associated firle; analyze the PDL (page description language) to reflect any job or page requirements that were not stated in the header; resolve any conflicts between the requirements of the job and the marking engine.configuration (i.e., RIP time mismatch resolution); keep accounting record and error logs and provide this information to any subsystem, upon request; communicate image transfer requirements to the marking engine; translate the data from PDL (page description language) to raster for printing; and support diagnostics communication between user applications. The RIP accepts a print job in the form of a page description language (PDL) such as postscript, PDF or PCL and converts it into raster, or grid of lines or form that the marking engine can accept. The PDL file received at the RIP describes the layout of the document as it was created on the host computer used by the customer. This conversion process is also called rasterization as well as ripping. The RIP makes the decision on how to process the document based on what PDL the document is described in. It reaches this decision by looking at the beginning data of the document, or document header.

Raster image processing or ripping begins with a page description generated by the computer application used to produce the desired image. The raster image processor interprets this page description into a display list of objects. This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the RIP rasterizes the byte map into a bit map for use by the printer. Half-tone densities are formed by the application of a halftone “screen” to the byte map, especially in the case of image objects to be printed. Pre-press adjustments can include the selection of the particular halftone screens to be applied, for example to adjust the contrast of the resulting image.

Electrographic printers with gray scale printheads are also known, as described in international publication number WO 01/89194 a2, incorporated herein by this reference. The ripping algorithm groups adjacent pixels into sets of adjacent cells, each cell corresponding to a halftone dot of the image to be printed. The gray tones are printed by increasing the level of exposure of each pixel in the cell, by increasing the duration by way of which a corresponding LED in the printhead is kept on, and by “growing” the exposure into adjacent pixels within the cell.

Once the document has been ripped by one of the interpreters, the raster data goes to a page buffer memory (PBM) 38 or cache via a data bus. The PBM eventually sends the ripped print job information to the marking engine 10. The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the rip. Once the images are in memory, they can be repeatedly read from memory and output to the print engine. The amount of memory required to store a given number of images can be reduced by compressing the images; therefore, the images may be compressed prior to memory storage, then decompressed while being read from memory.

As the pages of the print job are ripped, the raster form must be stored in intermediate storage so that as a substrate surface is in position for ink to be applied, the raster representation is available to specify how each raster of ink is to be rendered onto the substrate. The PBM is used to maintain this intermediate storage and needs to be managed in an optimal way for maximizing printer output speed.

As described earlier, the marking engine maintains a substrate (or media, such as paper) path that delivers the substrate and then fuses the ink into the substrate to form a strong bond such that the ink cannot be separated from the substrate. Fusing is usually done with pressure and heat. Applying heat to the paper may cause the substrate to shrink, particularly when printing in the duplex mode. To this end, printing in duplex mode can cause different shrinkage factors for the front and the back side of the substrate. Shrinkage factors can be problematic, especially for forms applications such as bubble forms that are automatically processed.

It is to be noted that the present invention applies to any change in size which occurs to a substrate on which a marking material is applied in a printing process. There are many types of printers and printing processes that transfer marking material in a representation of an input image onto a substrate, and wherein the printing process causes a change in size of the substrate. The present invention takes into account such changes and scales the input image in accordance with such changes which are effected upon the substrate. For instance, the substrate changes may be due to heat, moisture, light, etc.

The amount by which a page shrinks if it is exposed to the heat of the fuser system depends on the physical characteristics of the paper and external factors like humidity, and therefore is difficult for the print engine to correct automatically. For instance, depending on the order in which the pages are processed by the printer, either the front or the back side may be slightly smaller than the other side.

An aspect of the present invention is to make corrections to attempt to make both sides of a duplex page to print the same size. This may be accomplished by scaling one image or both the front and back images before they are rendered with factors that will result in both images being the same size after they have been printed.

In most cases it is sufficient to scale just one page (the one that appears bigger) down to the size of the other page. In some cases it may be necessary to scale both pages up so that they are printed at as close to their design size as possible, in which case it may not be possible to print the image over the full size of the page since a margin may be required around the actual page content.

To determine the scaling factor that needs to be applied to the page, a test print is measured and a scaling factor is calculated. A test print may have horizontal and vertical lines with known dimensions. Once these lines are measured, it is possible to calculate a correction factor for one or both sides. Software may perform this calculation automatically. The user would provide the measured dimensions through the GUI. The software would “know” what the original lengths of the lines were and can therefore calculate the correction factor.

Because the shrinkage factor can be different between the in-track and cross-track direction, it may be necessary to measure and calculate two factors for these two directions. It may also be necessary to shift one or both sides by a small amount.

If only one image needs to be adjusted (which means that it is not necessary to scale both images to their design size), the following approach may be used. The terms “larger” and “smaller” page image are used, regardless of the order in which the images are printed. The example calculation is also only performed for one direction, although it may be necessary to scale the image in both the horizontal and vertical dimension.

If the design size of the lines is 10 units, and the measured print has a line length of 9 units on the larger page image, and a line length of 8 units on the smaller page image, the following calculation will give the necessary scaling factor that needs to be applied to the larger image in order to scale it down to the size of the smaller printed image:
scale=sm/lg

Where:

scale is the scaling factor

sm is the length of printed line on smaller page image

lg is the length of printed line on larger page image

If both images need to be scaled up to the design size, the following approach may be used:
scale_sm=d/sm
scale_lg=d/lg

Where:

scale_sm is the scaling factor for the smaller page image

scale_lg is the scaling factor for the larger page image

sm is the length of printed line on smaller page image

lg is the length of printed line on larger page image.

d is the design length of line

Every scaled page image may need to be shifted by a small amount in the horizontal and/or vertical direction. This shift value can either be calculated based on the scaling factors, or specified by the user.

The scaling factor of the present invention may be added or applied as part of an annotated bit-map version of the digital image. For instance, one way to implement this is to add the scaling factor to the IFD. The IFD block containing the scaling factor may be a new IFD block added to the TIFF file. For PDF this would be to modify the transformation matrix at the start of a page by adding the following line to the start of a PDF page content stream:

0.9 0.0 0.0 0.8 0.0 0.0 cm

The “cm” command will concatenate the current transformation matrix with the specified transformation matrix. In this case, the page would be scaled to 90% vertically and 80% horizontally, with no shift. The general format is

a b c d x y cm

where x and y would be used to shift the image and a and d are the horizontal and vertical scaling factors. The other parameters can be used to rotate or shear the page, or create compound transformations.

The PDF Reference, fourth edition, Version 1.5 available from Adobe® provides further information on PDF specifications and formatting.

In addition to modifying the page content on the page level, it is also possible to apply the scaling (and shifting) to every single page object. Once the scaling factor is determined, the printer controller feeds the digitized scaled image to the marking engine as described hereinbefore to account for fuser shrinkage of the substrate thereby transfer properly scaled image onto substrates before fusing so that post fused printed materials appear properly scaled and aligned.

The scaling factor may also be added and stored in a data block of the data component, rather than an IFD block.

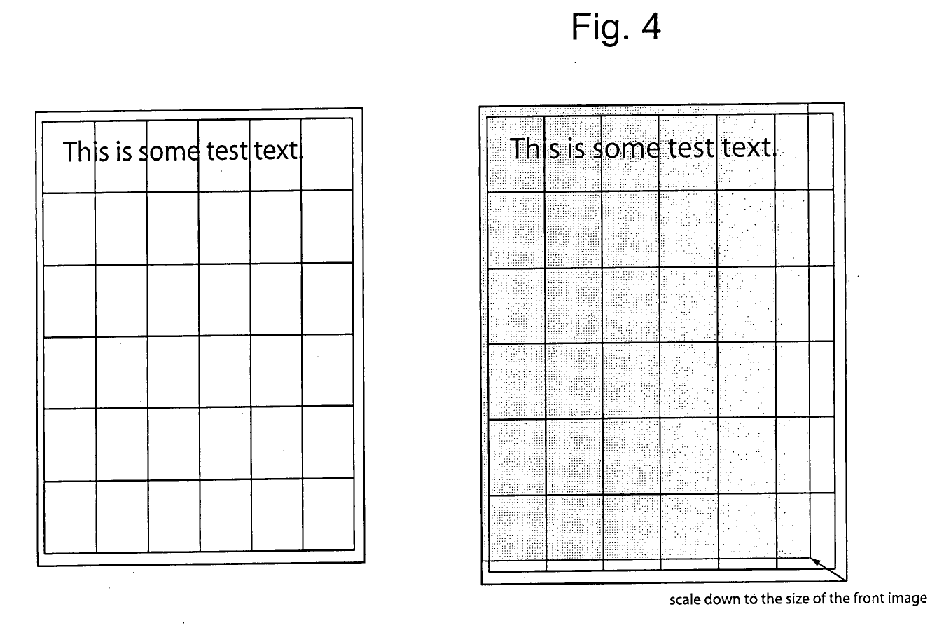

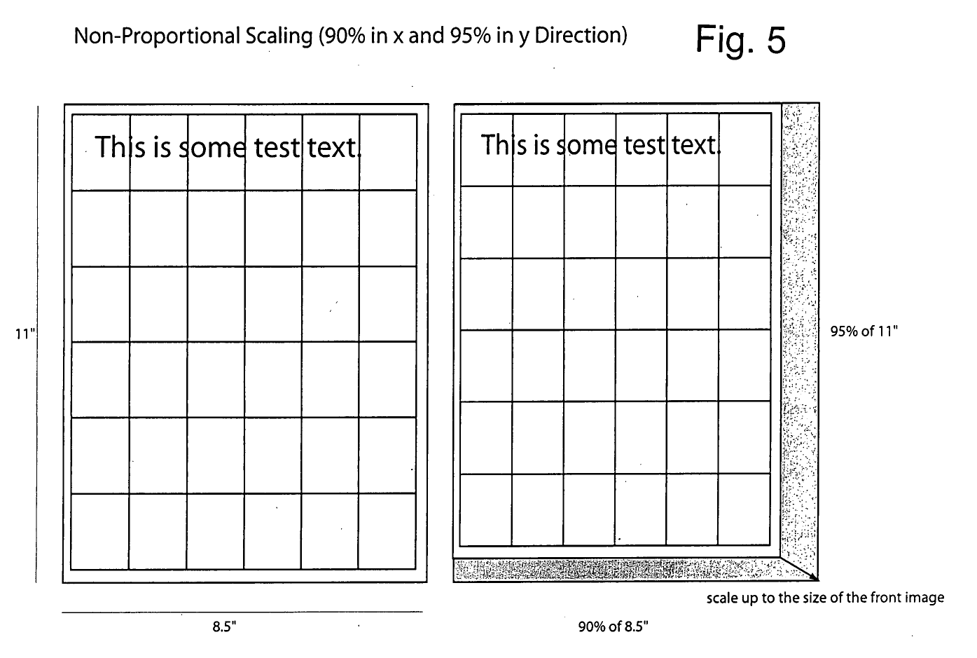

FIGS. 4 and 5 illustrate examples of how one side of a sheet is scaled up, or scaled down to match the other side. The illustrations assume that the x-direction shrinks to 90%, and the y-direction to 95% and are exemplary shrinkage values only.

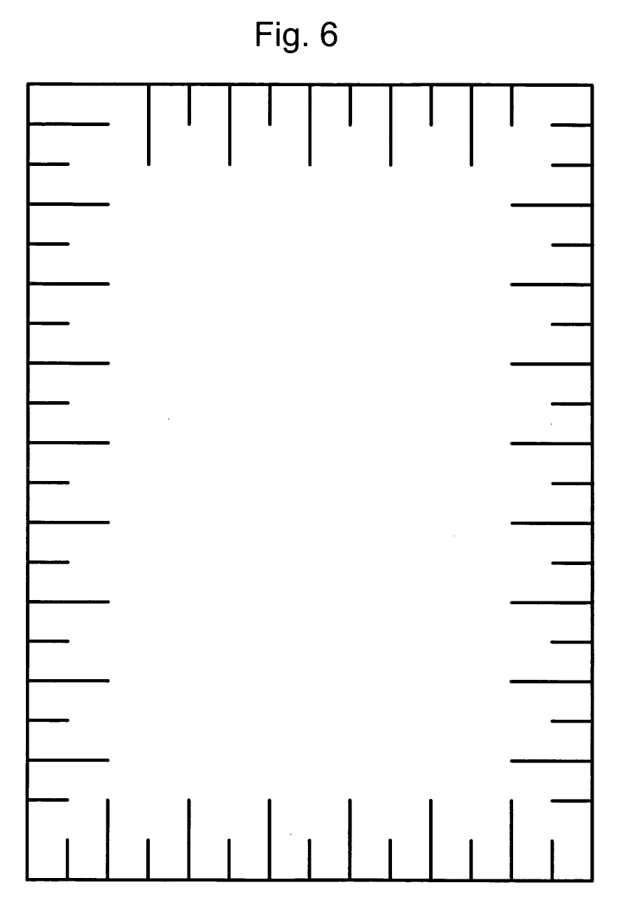

FIG. 6 illustrates an exemplary test page.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

1. A printer for printing an input digitized image on a substrate comprising:
a receiver for receiving the input digitized image;
a transfer unit for transferring a marking material representation of the image onto the substrate;
a fuser unit for heating the marking material and substrate to thereby fix the marking material to the substrate; and,
a controller for scaling the digitized input image to account for shrinkage of the substrate due to the fuser unit heating.

2. A printer in accordance with claim 1, wherein the controller scales the image according to a scaling factor.

3. A printer in accordance with claim 2, wherein the scaling factor is a function of the ratio of the difference between image size before fusing and after fusing.

4. A printer in accordance with claim 1, wherein scaling comprises shifting the image.

5. A printer in accordance with claim 2, wherein the scaling factor is added to an image file directory of the input digitized image.

6. A printer in accordance with claim 2, wherein the scaling factor is added to a data block of the input digitized image.

7. A method for printing an input digitized image on a substrate comprising the steps of:
receiving the input digitized image;
transferring a marking material representation of the image onto the substrate;
heating the marking material and substrate to thereby fix the marking material to the substrate; and,
scaling the digitized input image to account for shrinkage of the substrate due to the heating.

8. A method in accordance with claim 7, wherein scaling is done according to a scaling factor.

9. A method in accordance with claim 8, wherein the scaling factor is a function of the ratio of the difference between image size before fusing and after fusing.

10. A method in accordance with claim 7, wherein scaling comprises shifting the image.

11. A method in accordance with claim 8, wherein the scaling factor is added to an image file directory of the input digitized image.

12. A method in accordance with claim 8, wherein the scaling factor is added to a data block of the input digitized image.

13. A printer in accordance with claim 2, wherein the scaling factor is added to a page content stream.

14. A method in accordance with claim 8, wherein the scaling factor is added to a page content stream.

15. A printer in accordance with claim 1, wherein scaling comprises scaling and shifting.

16. A printer in accordance with claim 2, wherein the scaling factor is a modification to a transformation matrix of the input digitized image.

17. A method in accordance with claim 8, wherein the scaling factor is a modification to a transformation matrix of the input digitized image.

18. A method for printing an input image on a substrate comprising the steps of:
receiving the input image;
transferring a marking material representation of the input image onto the substrate; and,
scaling the input image to account for a change in size of the substrate due to printing.

19. A method in accordance with claim 18, wherein scaling is done according to a scaling factor.

20. A method in accordance with claim 19, wherein the scaling factor is a function of the ratio of the difference between image size before printing and after printing.

21. A method in accordance with claim 18, wherein scaling comprises shifting the image.

22. A method in accordance with claim 19, wherein the scaling factor is added to an image file directory of the input image.

23. A method in accordance with claim 19, wherein the scaling factor is added to a data block of the input image.

24. A method in accordance with claim 19, wherein the scaling factor is added to a page content stream.

25. A method in accordance with claim 19, wherein the scaling factor is a modification to a transformation matrix of the input image.
